(19) United States
(12) Patent Application Publication
(10) Pub. No.: US 2009/0018864 A1
(43) Pub. Date: Jan. 15, 2009

(54) Method and system for ensuring compliance with mandated pre-operative policies and procedures to prevent wrong-site surgeries

(76) Inventor: Gary Raymond Gecelter, Great Neck, NY (US)

Correspondence Address: FAEGRE & BENSON LLP;PATENT DOCKETING, 2200 WELLS FARGO CENTER, 90 SOUTH SEVENTH STREET, MINNEAPOLIS, MN, 55402-3901, US

(21) Appl. No.: 11/825,896

(22) Filed: Jul. 9, 2007

(51) Int. Cl. G06Q 50/00

(52) U.S. Cl. 705/2; 128/898

(57) ABSTRACT

There are provided systems and methods for ensuring compliance with mandated pre-operative policies and procedures to prevent wrong site surgeries. In an embodiment, at least two operating room personnel perform a pre-operative assessment prior to a scheduled surgical procedure. The at least two participants to the pre-operative assessment provide some indicia of their personal identity as a form of attestation to their respective participation in the pre-operative assessment. Upon verifying the submitted indicia of personal identification information received from each of the at least two operating room personnel participants to the assessment, critical operating room lighting fixtures and critical outlets are switched from an initialized disabled state to an enabled state to permit activation by the operating room personnel to allow the procedure to run its normal course. In another embodiment, a recording device is activated prior to the start of a pre-operative assessment. At least two participants perform a pre-operative assessment while the recording device is activated. The recording device is then de-activated at the conclusion of a pre-operative assessment. Responsive to the de-activation of the recording device, operating room lighting fixtures and critical outlets are switched from a disabled state to an enabled state. Accordingly, a failsafe method is provided for ensuring strict compliance with the performance of the pre-operative assessment in a timely manner. The system and method is dependent upon a repeatable obligatory behavior that is easily implemented and can be added to existing physical infrastructure at a very low cost.

### BACKGROUND OF THE INVENTION

1. Field of the Invention

The present invention relates generally to systems and methods for reducing the likelihood of wrong site surgery. More particularly, the present invention relates to systems and methods related to assuring compliance with pre-operative policies and procedures to prevent wrong site surgeries.

2. Description of the Related Art

Wrong site surgery (WSS) is defined as: a) the wrong operation performed on a patient, b) an operation performed on the wrong patient or c) an operation performed on the wrong body part. Wrong site surgery is characterized as a preventable medical error and thus great efforts are being made to reduce the incidence of WSS.

Numerous infamous cases of wrong-site surgeries have caused much attention to be focused on the need to prevent or deter surgeries from being performed on the wrong limbs or body parts. Various factors are believed to contribute to the occurrence of wrong-site surgeries including failures of communication, documentation and/or preoperative assessment; the involvement of more than one surgeon in a particular case; the need to perform multiple surgical procedures on a patient at one time, particularly on different sides of the patient's body; time pressures involving a hastening of start times and/or preoperative procedures; and unusual patient characteristics, such as physical deformity or obesity, which alter the usual processes for equipment set-up, patient preparation and/or patient positioning.

The Joint Commission on Accreditation of Healthcare Organizations. Sentinel Event Alert, issue six, Aug. 28, 1998, offers the following possible strategies for reducing the risk of wrong-site surgery: Clearly mark the operative site and involve the patient in the marking process to enhance the reliability of the process; Require an oral verification of the correct site in the operating room by each member of the surgical team; Develop a verification checklist that includes all documents referencing the intended operative procedure and site, including the medical record, X-rays and other imaging studies and their direct observation of the marked operative site on the patient; Personal involvement of the surgeon in obtaining informed consent; Ensure through ongoing monitoring that verification procedures are followed for high-risk procedures; and “Time out” immediately before starting the procedure.

Despite the implementation of strategies to prevent wrong patient, wrong site, wrong side surgery, regrettably this seemingly most preventable of complications still occurs. Current methodologies to prevent WSS include the use of indelible markers and adhesive labels to identify appropriate surgical sites, a micro-chip attached to the patient at the anatomical location of the intended surgery which is scanned to retrieve electronically stored information prior to surgery to correlate a patient with the surgery to be performed, and patient safety alerting systems and methods including a display device for displaying a set of indicators, each indicator displaying one of a plurality of indicator states, each of the indicator states indicating a level of compliance with a patient safety procedure. These methodologies have inherent deficiencies and wrong site surgery continues to occur. A zero-tolerance policy for wrong site surgery has been mandated by major agencies and professional organizations that accredit health care providers. In accordance with this policy, the term ‘Never Event’ has been coined by the National Quality Forum (www.qualityforum.org). Therefore, a need exists for better methods to further reduce the likelihood of wrong site surgery.

### SUMMARY OF THE INVENTION

Therefore, the present invention has been made in view of the above problems, and it is an objective of the present invention to provide methods and systems for ensuring compliance with mandated pre-operative policies and procedures to prevent wrong site surgeries. The methods and system for use with a patient scheduled to have a procedure at a particular site on the patient's body,

In accordance with one aspect of the present invention, the afore-mentioned objective is achieved by providing a method for use with a patient scheduled to have a procedure at a particular site on the patient's body. The method assures compliance with pre-operative policies and procedures to prevent wrong site surgeries. In one embodiment, the method includes the steps of: performing a pre-operative assessment regarding a patient scheduled to have a procedure at a particular site on the patient's body. The assessment being performed by at least two members from among the attendant medical personnel to the procedure. The at least two members may be selected from the group consisting of, for example, an operating room physician, an operating room physician assistant, an operating room anesthesiologist, an operating room technologist, a nurse, a nursing staff member. The assessment may comprise a review of provided patient data, such as, a patient chart scheduled for surgery, informed consent forms and the like. At the conclusion of the pre-operative assessment, at least two participants to the pre-operative assessment are required to submit some indicia of their personal identification to the system as a confirmation of their participation in the pre-operative assessment. The method further includes verifying the submitted indicia of personal identification by the system. In the event, the submitted indicia is successfully verified by the system, the system, via lighting control means, switches the operating room lighting, and critical electrical outlets, from its initialized disabled state to an enabled state to permit activation by the operating room personnel to allow the procedure to proceed in its normal course.

In an exemplary illustrative embodiment, the operating room lighting, and critical electrical outlets are initialized to a disabled state. The operating room lighting and critical electrical outlets are only switched from their initialized disabled state to an enabled state upon verifying that at least two operating room personnel attest to their participation in a pre-operative assessment. In the exemplary illustrative embodiment, verification occurs via the submission of some indicia of personal identification from the at least two operating room personnel. In the case where the submitted indicia of personal identification is successfully verified by the system, the operating room lighting, and critical electrical outlets, are switched from their initialized disabled state to an enabled state by control means, to permit activation by the operating room personnel.

In one embodiment, the patient may attest to having been informed of pre-operative related information prior to the start of a procedure. For example, a patient may attest to the fact that one of the operating room personnel has verbalized to the patient, the patient's demographic information, the title of the procedure to be performed and the site of the procedure. The patient may attest by signing an electronic document. Additionally, the patient may submit some indicia of personal identification to corroborate his or her electronic attestation.

In accordance with one embodiment, the invention is a system for use with a patient scheduled to have a particular procedure at a particular site on the patient's body where the procedure is to be performed in a procedure room. The system assists in preventing the particular procedure of each patient being performed at a site on each patient's body other than the particular site by controlling the activation of operating room lights, and critical electrical outlets. In a pre-operative stage, system control means sets the operating room lights, and critical electrical outlets, to an inoperable state until such time as verification means of the system verifies that at least two operating room personnel have submitted some indicia of personal identification. Upon verifying the submitted personal identification information, the system control means switches the operating room lights, and critical electrical outlets, from the previously disabled state to an enabled state, to permit activation by the operating room personnel. Otherwise, in the event that the system verification means determines that the verification procedure has failed, the operating room lights, and critical electrical outlets, remain in the initialized disabled state. In this case, a verification failure results in preventing the surgery from proceeding.

According to one aspect, submission of personal identification information from at least two members from among the operating room personnel provides indicia that a preoperative assessment was performed at a specific date and time by virtue of a system stamp.

According to another aspect of the invention, the system advantageously provides post-operative information regarding the completed procedure, such as, for example, date and time-stamp information, as discussed above, a description of the surgical procedure, the patient, and the specific operating room personnel present for the procedure. This information may be made available in a time ordered report form.

According to yet another aspect, the system is configured to simultaneously monitor/control the operating room lighting, and critical electrical outlets, for multiple operating rooms.

As will be apparent, the present invention may generally benefit patients in operating room settings and other situations by providing safeguards to prevent the occurrence of wrong site surgeries. More particularly, it will be appreciated that the improved compliance procedures, systems and methods disclosed herein will reduce and potentially eliminate the occurrence of wrong site surgeries.

According to one aspect, the attestation from the at least two participants may be input to the system in accordance with methods for using voice, word, sound and/or other forms of biometric and non-biometric input. The various methods and systems described herein can be deployed as stand-alone, multifunctional biometric platforms, or as integrated parts of broader technology environments.

Advantages of the invention may include one or more of the following. A failsafe method for ensuring strict compliance with the performance of a pre-operative assessment. By enforcing strict compliance with the assessment in a pre-operative stage, the possibility of not performing the assessment or affirming that an assessment was performed in a post-operative stage is precluded. By controlling operating room light activation via strict compliance with the submission of personal identification information, the identification of at least certain critical members of the operating room personnel present for the procedure is assured. The method and system is dependent upon a repeatable obligatory behavior that is easily implemented and can be added to existing physical infrastructure at a very low cost.

### BRIEF DESCRIPTION OF THE DRAWINGS

These and other objects, features and advantages of the invention will be apparent from a consideration of the following Detailed-Description Of The Invention considered in conjunction with the drawing Figures, in which:

FIG. 1 illustrates a typical operating room environment in which the present invention may be practiced;

FIG. 2 is a block diagram of a system of the invention, according to one embodiment; and

FIG. 3 is a flow diagram illustrating a process for use with a patient scheduled to have a procedure at a particular site on the patient's body, the process being directed to assuring compliance with pre-operative policies and procedures to prevent wrong site surgeries, in accordance with an embodiment of the invention.

FIG. 4 is a flow diagram illustrating a process for use with a patient scheduled to have a procedure at a particular site on the patient's body, the process being directed to assuring compliance with pre-operative policies and procedures to prevent wrong site surgeries, in accordance with an embodiment of the invention.

### DETAILED DESCRIPTION OF THE PREFERRED-EMBODIMENTS

### 1. Introduction

In the following discussion, numerous specific details are set forth to provide a thorough understanding of the present invention. However, those skilled in the art will appreciate that the present invention may be practiced without such specific details. In other instances, well-known elements have been illustrated in schematic or block diagram form in order not to obscure the present invention in unnecessary detail. Additionally, for the most part, details concerning network communications, electromagnetic signaling techniques, and the like, have been omitted inasmuch as such details are not considered necessary to obtain a complete understanding of the present invention and are considered to be within the understanding of persons of ordinary skill in the relevant art.

It is further noted that, unless indicated otherwise, all functions described herein may be performed in either hardware or software, or some combination thereof In a preferred embodiment, however, the functions are performed by a processor, such as a computer or an electronic data processor, in accordance with code, such as computer program code, software, and/or integrated circuits that are coded to perform such functions, unless indicated otherwise.

The following paragraphs describe an overview of the invention and an exemplary embodiment for assisting in preventing a procedure from being performed at a site on the patient's body other than an intended site.

### 2. Overview

In accordance with the present invention, there are provided herein methods and systems for use with a patient scheduled to have a procedure at a particular site on the patient's body, the method for assisting, in preventing the procedure being performed at a site on the patient's body other than the particular site.

A key feature of the invention is that operating room lighting, and critical electrical outlets, are maintained in an inoperable state until such time as at least two members from among the operating room personnel, participate in a pre-operative assessment, and attest to their participation in the pre-operative assessment by submitting some indicia of their identity to a system configured to process and verify the submitted indicia of personal identity. Upon verifying the identity of the participants, the operating room lighting, and critical electrical outlets are switched from an inoperable state to an operable state to permit activation by the operating room personnel.

By switching the operating room lighting, and critical electrical outlets, to an operable state, responsive to the submission and subsequent verification of some indicia of personal identity from at least two members of the operating room personnel, a number of objectives are simultaneously achieved. They include, mandating that a dedicated “time-out” occurs just prior to the commencement of the procedure in order to perform a pre-operative assessment by certain of the operating room personnel. By demanding a time-out prior to the start of a surgical procedure, the pre-operative assessment is taken more seriously by both the nursing staff and the operating staff.

Another objective that is achieved is the verification of the identities of the of the at least two operating room personnel. Verification comprises verifying the presence and availability of the at least two operating room personnel to perform a pre-operative assessment.

Thus, as will become apparent, the invention provides an easily implemented repeatable procedure that is intended to minimize, if not eradicate wrong site surgeries by enforcing a time-out procedure, to perform and attest to the performance of a pre-operative assessment to assure patient safety. As described below, the procedure can be easily added to existing physical infrastructure at a very low cost.

### 3. First Embodiment

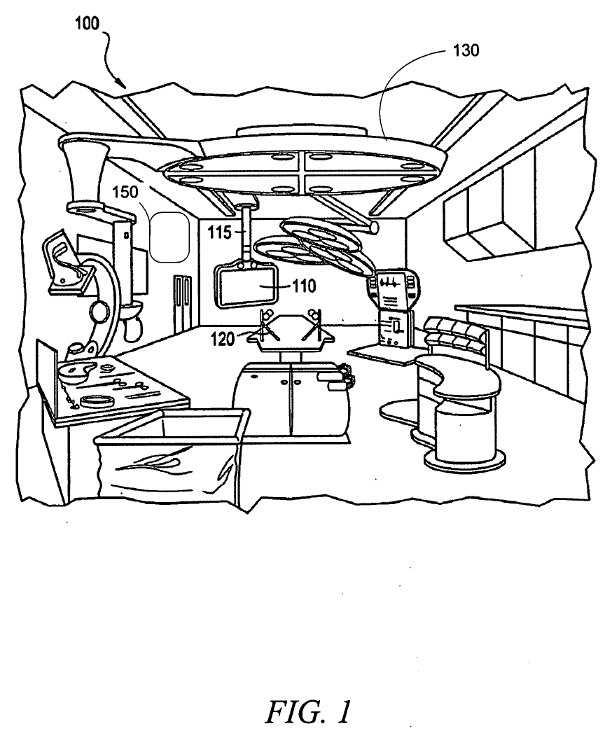

Referring now to the drawings, FIG. 1 shows an operating room 100 in which the invention may be practiced. The operating room environment 100 includes conventional operating room lighting fixtures 130, such as the Genesis/Genie Plus™ series lights manufactured by Buckeye Medical Systems of Colton, Calif., a single large format display 110 suspended on a boom 115 near an operating table 120. In other embodiments, the single display may be substituted for a multiplicity of displays.

An important aspect of this invention relates to the control of the operating room lighting fixtures 130 and critical electrical outlets. More particularly, the operating room lighting fixtures 130 and critical electrical outlets are controlled by a processing unit (i.e., host computer) 155 situated outside of the operating room. The processing unit 155, via well-known control means, initializes the operating room lighting fixtures 130 and critical electrical outlets to an inoperable (disabled) state, effectively preventing the continuance of the surgical procedure until such time as a pre-operative assessment has been performed and the participants attest to their participation. This is accomplished, in one way, via a software module or program running on the processing unit 155 that is programmed to switch the operating room lighting fixtures 130, and critical electrical outlets, to an operable (enabled) state upon successfully verifying the submission of some indicia of personal identification from at least two operating room personnel, who, via the submission of personal identification, attest to their respective participation in the pre-operative assessment.

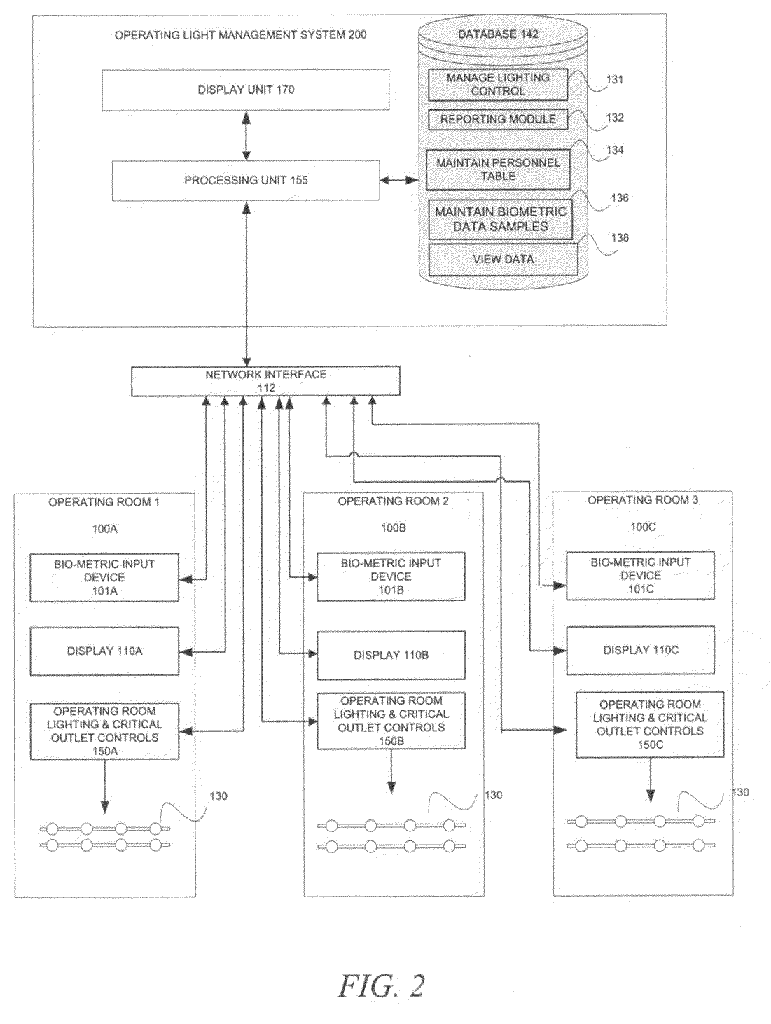

With reference now to FIG. 2, the system 200 includes a network interface 112 for connecting an operating room lighting management system 200 to multiple operating rooms 101A-C of a hospital environment. Three of which are shown by way of example and not limitation. It should be understood that the term hospital environment should be construed broadly herein to mean any medical care facility, including but not limited to a hospital, treatment center, clinic, doctor's office, day surgery center, hospice, nursing home.

The lighting management system 200 includes a processing unit 155 that performs various operations, described in greater detail below. The lighting management system 200 further includes a display/input device 170 for communicating with the processing unit 155 and for allowing a user to receive information from the processing unit 155 and/or input information into the processing unit 155. Those of ordinary skill in the art will appreciate that display/input device 170 may be provided as a separate display device and a separate input device.

The lighting management system 200 further includes an electronic storage medium 142 for communicating with the processing unit 155 and for storing programming code and data necessary for the processing unit 155 to perform critical system functions. More specifically, the storage medium 142 stores multiple programs formed in accordance with the present invention for various system functions including but not limited to the following programs: Manage Lighting Control 131, Reporting Module 132, Maintain Personnel Table 134, Maintain Biometric Data Samples 136, and View Data 138.

The Manage Lighting Control program 131 manages the operational state of the operating room lighting and critical outlets by performing verification processing on submitted identification information from the operating room personnel. The submitted identification information is delivered to the lighting management system 200 via biometric input devices 101A-C located in the operating room 100. In an embodiment, the operating room lighting 130 and critical outlets are switched between an enabled and a disabled state via locally situated control units 150A-C. In an embodiment, the control units 150A-C may operate in a lock box fashion. That is, upon verifying submitted identification information from at least two operating room personnel by the Manage Lighting Control program 130, an access panel on the control units 150A-C may open in response to allow activation of the operating room lighting 130 and critical electrical outlets by the operating room personnel.

The Reporting Module program 132 reports pre and post-operative information regarding the procedure, such as, for example, date and time-stamp information pertaining to the date and time at which the at least two operating room personnel attested to their participation in a pre-operative assessment via the submission of personal identification information, a description of the surgical procedure and the patient.

The Maintain Personnel Table program 134 manages the list of operating room personnel who are registered to participate in procedures performed in the various operating rooms 101A-C. After the operating room personnel's information is entered into database 142, the operating room personnel may be defined as registered operating room personnel. Of course, the operating room personnel information stored in database 142 is kept strictly confidential, and access to such information is monitored to ensure privacy.

The Maintain Biometric Data Samples 136 program maintains at least one, and preferably more biometric samples received from the registered operating room personnel.

Further, while the operating light management system 200, as described herein, appears as a single entity, there may be more than one system operating harmoniously and sharing the same database. For example the system 200 can be duplicated to run on distinct servers in order to avoid a single point of failure, address availability requirements, and handle a high volume of operating procedures. In this example, each individual processor 155 operates in conjunction with other processors to balance the workload.

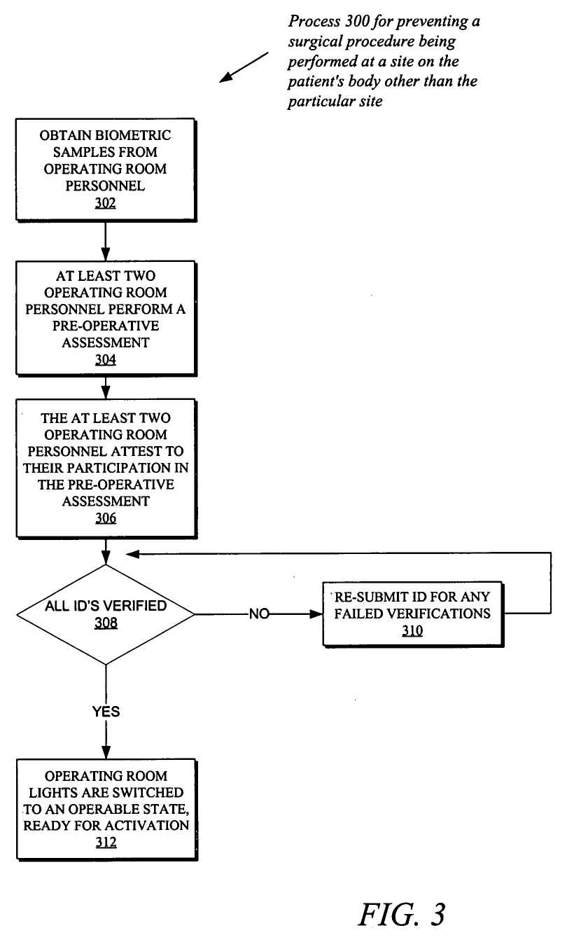

FIG. 3 is a flow diagram illustrating a process 300 for use with a patient scheduled to have a procedure at a particular site on the patient's body, the process being directed to ensuring compliance with mandated pre-operative policies and procedures to prevent wrong site surgeries, in accordance with one embodiment of the invention.

At act 302, during an enrollment stage, at least one biometric sample is taken of each of the registered operating room personnel who regularly participate in operating room procedures, for registration in a database 142. Later, as will become apparent to the reader, biometric information may be provided by the operating room personnel to verify participation in a pre-operative assessment by certain of the operating room personnel. It should be appreciated that this step is only performed in an embodiment in which biometric samples are used for verification purposes.

In some embodiments, more than one biometric sample may be registered. If in providing a first piece of biometric information, a match can not be found, then the method may allow a second piece of biometric information to be provided in an effort to verify that a pre-operative assessment has been performed using the second piece of biometric information. The ability to authorize a transaction through the use of more than one biometric sample may be important if the biometric sample becomes altered, or the body part that provided the biometric sample becomes altered or injured.

At act 304, just prior to the start of a surgical procedure, at least two operating room personnel involved in the surgical procedure perform a pre-operative assessment. It is understood by those knowledgeable in the medical arts that the general objective of a pre-operative assessment is to ascertain the health of a patient who is to undergo surgical intervention, with the aim of controlling and reducing the risks relating to anesthetic and surgery and thereby foster a high quality of care for the patient. The pre-operative assessment typically includes a review of patient data, such as, a patient chart scheduled for surgery, informed consent forms and the like. In some instances, the assessment may verify that the site selection was done properly, i.e. the site selected is actually the site at which the procedure is to occur. In some instances, key personnel may be required to also verify that the correct patient is in the operating room (OR) and that the correct procedure is about to be performed. In most cases, however, the assessment usually takes the form of a nurse verbalizing the patient's demographic information, title of the procedure and site of the procedure.

At act 306, upon completion of the pre-operative assessment, at least two operating room personnel participating in the pre-operative assessment attest to their participation in the pre-operative assessment by submitting some indicia of their personal identity to the host computer 155 to be verified by the host computer 155. In an embodiment in which biometric indicia is utilized, the personal biometric identity information may be submitted via a biometric input device 150 (see FIG. 1)located in the operating room. This biometric input device 150 is also shown in FIG. 2, 101A-C.

The present invention contemplates the use of any type of well-known or envisioned biometric identification system for use in submitting operating room personnel identity information in accordance with the verification procedure. Some representative systems contemplated for use include, without limitaion, fingerprint identification systems, which may require the individual being identified to place their finger on a visual scanner, hand and face identification systems which use scanners or cameras to detect the relative anatomical structure and geometry of the person's face or hand, retinal scans where a person places their eye close to or upon a retinal scanning device. The scanning device will scan the retina to form an electronic version of the unique blood vessel pattern in the retina. An iris scan records the unique contrasting patterns of a person's iris. Other types of technologies contemplated for use include biometric identification of behavioral traits. Voice recognition systems generally use a telephone or microphone to record the voice pattern of the user received. Usually the user will repeat a standard phrase, and the device compares the measured voice pattern to a voice pattern stored in the system. Signature authentication is a more sophisticated approach to the universal use of signatures as authentication. Biometric signature verification not only makes a record of the pattern of the contact between the writing utensil and the recording device, but also measures and compares the speed of the writing and pressure applied in the process of writing such as, for example, fingerprint identification,

In some embodiments, the at least two operating room personnel participating in the pre-operative assessment may verify their participation in the pre-operative assessment by providing some indicia of non-biometric identity information, such as, for example, a magnetic stripe card. Of course, in other embodiments, it is contemplated to use various combinations of biometric and non-biometric systems, which should be apparent to the reader.

At act 308, the biometric information provided by the at least two operating room personnel at act 306 is verified by the operating light management system 200. Verification may comprise comparing the currently provided biometric information from the at least two operating room personnel with previously stored biometric samples, provided during a registration stage, as discussed above. A determination is then made, based on the comparison, whether the currently provided biometric information from the at least two operating room personnel matches their respective previously stored biometric samples, which were registered with the system 200. An audio/visual indication may be provided as an indication as to whether the currently provided biometric information matches the registered biometric samples.

At act 310, if it is determined at act 308, that the verification test has failed for any of the at least two participants, then a re-submission of some indicia of personal identity is required from the failed participants. In some embodiments, an audible and/or visual indication may be provided to indicate that a test failure has occurred. In some embodiments, the re-submission may use the same biometric or non-biometric sample or a different biometric or non-biometric sample. For example, if an iris test fails, then a participant may be required to supply a fingerprint sample if such a sample is on file for that participant.

At act 312, if it is determined that the biometric information on file matches the currently provided biometric sample for the at least two operating room personnel making the attestation, the host computer 155 initiates a command to switch the operating room lighting 130 and critical electrical outlets from a current inoperable (disabled) state to an operable (enabled) state to allow the surgery to take place under its normal course. In some embodiments, an audible and/or visual indication may be provided to indicate that a successful test verification has occurred.

In the process described above, act 308 through act 310 may be repeated as many times as a participant submits incorrect biometric/non-biometric verification information. Alternatively, act 308 through act 310 may be repeated until a predetermined number of attempts is reached, at which point the operating light management system 200 does not further respond.

### 4. Second Exemplary Embodiment

In one embodiment, the participants to a pre-operative assessment may be filmed (recorded) while performing the pre-operative assessment. At the start of the assessment, a recording device (e.g., a video camera having or supplemented by audio capabilities) is started. At the end of the pre-operative assessment, it is contemplated to require at least two participants to stand before the recording device and visually/verbally attest to his or her participation in the pre-operative assessment. At the end of the last attestation in front of the recording device, the recording device is stopped which automatically triggers the operating room lighting 130 and critical electrical outlets to be switched from an initialized disabled state to an enabled state. At this point, the operating room lighting and critical electrical outlets may be activated (i.e., switched on) by the operating room personnel to allow the scheduled procedure to continue in its normal course.

Embodiments of the present invention can be practiced with a camera that takes motion pictures such as would be taken by a camcorder or other device that records active movement. It is further noted that the camera is not limited to a traditional digital recording device or digital camcorder. Indeed, any device that will have as its function the ability to capture an image and convert it to an electronic format or electronically readable format will suffice to practice the invention. The recording device of the present embodiment will be adapted to automatically focus on preferably the head and shoulders of the participants to a pre-operative assessment, which results in defocusing of the background surrounding the participants. However, other embodiments can have a recording device adapted to focus on other portions of the participants. Further, the present invention can be practiced with a recording device that does not automatically focus, but instead remains focused on a point or location at a predetermined specified distance from the recording device. In such a case it would be up to the participants to position themselves at an appropriate distance from the recording device. Recognizing that this embodiment does not produce as clear an image as the automatically focusing recording device an embodiment could possibly have a software mechanism or a computer mechanism to sharpen the image and correct for the fact that the image is not in proper focus. Also, the present invention can be practiced with a device that will allow the user to focus the recording device.

The recording device, or at least some components of the recording device, of the preferred embodiment will be adapted to move or be moved in a variety of directions to accommodate, say, the height and/or the location of the user or users. To enable the recording device to move, the embodiment will support the recording device with a multi-directional adjustable mount which can be adjusted, for example, by electrical motors. This multi-directional mount could be controlled by a control unit, or could be directly controlled by the user, or controlled through shared control or alternating control by the user and the control unit. Also, the recording device could be adapted to change the angle of view. For example, when multiple users desire their image to be captured at the same time or, alternatively, a particularly large user desires his or her image to be captured, a wide angle image will be captured. The angle of view can be controlled in at least the same or similar ways as just mentioned in regard to the control of the multi-directional mount.

The recording device of the preferred embodiment may be a color, high resolution camera. However, the present invention can be practiced with a black and white camera or a gray tone camera or a camera that detects and/or captures and/or outputs color in some color frequencies but not all color frequencies. As noted above, the recording device will preferably have the ability to take both wide angle and narrow angle pictures, thus permitting multiple users to have their image taken, or alternatively to vary the margins on either side of, say, the face of a single user, or to vary the margins around, say, a group of users. The video camera is preferably provided with a speaker or speakers which will record audio information.

To reduce the quantity of information to store and at the same time to have a sufficient quality of the video, some embodiments may utilize frame capturing in which the video is preferred to have between 12 and 15 images a second in the QCIF format (Quarter Common Interchange Format with 144×176 pixels) in black and white. The video signal having the above characteristics is compressed by a digital signal processor based on a programmable MAC (Multiply and Accumulate). The compression method used is preferably that written in Recommendation H263 of ITU-T (Line transmission of telephone signals: video coding for low bitrate communication). It is possible in further embodiments to use other methods of compression such as those written in the Standard ISO/IEC 13818-Information Technology-Generic codec of moving pictures and associated audio information-1966.

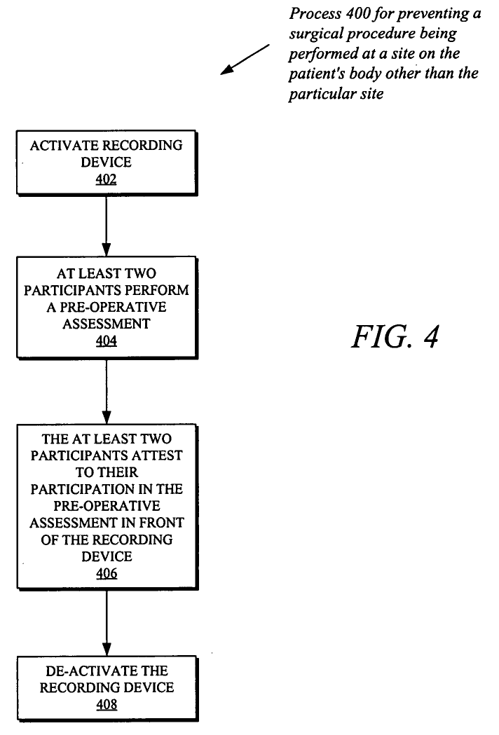

FIG. 4 is a flow diagram illustrating a process 400 for use with a patient scheduled to have a procedure at a particular site on the patient's body, the process being directed to ensuring compliance with mandated pre-operative policies and procedures to prevent wrong site surgeries, in accordance with one embodiment of the invention.

At act 402, recording device, such as a video camera, is activated which may be moved in a variety of directions to accommodate, say, the height and/or the location of the participants to a pre-operative assessment.

At act 404, at least two operating room personnel stand within view of the recording device to perform a pre-operative assessment. It is understood by those knowledgeable in the medical arts that the general objective of a pre-operative assessment is to ascertain the health of a patient who is to undergo surgical intervention, with the aim of controlling and reducing the risks relating to anesthetic and surgery and thereby foster a high quality of care for the patient. The pre-operative assessment typically includes a review of patient data, such as, a patient chart scheduled for surgery, informed consent forms and the like. In some instances, the assessment may verify that the site selection was done properly, i.e. the site selected is actually the site at which the procedure is to occur. In some instances, key personnel may be required to also verify that the correct patient is in the operating room (OR) and that the correct procedure is about to be performed. In most cases, however, the assessment usually takes the form of a nurse verbalizing the patient's demographic information, title of the procedure and site of the procedure.

At act 406, an optional step, at the end of the pre-operative assessment, at least two participant to the pre-operative assessment directly face the recording device and verbally attest to his or her participation in the pre-operative assessment. For example, a physician, who is one participant in the scheduled procedure, may state to the recording device—“I hereby attest to my participation in the pre-operative assessment of said patient at a particular date and time”.

At act 408, when the last participant of the at least two participants has attested to his or her participation in the pre-operative assessment in accordance with act 406, the recording device is de-activated. This triggers the operating room lighting 130 and critical electrical outlets to be automatically switched from their initialized inoperable (disabled) state to an operable (enabled) state to allow the scheduled procedure to continue under its normal course.

In some embodiments, the at least two participants may further be required to undergo a verification procedure, similar to that described above.

In some embodiments, activation of the operating room lighting fixtures and critical outlets may not be allowed unless it is determined that a sufficient time has elapsed between activation and deactivation, e.g., 15 minutes.

In some embodiments, activation of the operating room lighting fixtures and critical outlets may not be allowed unless certain key phrases are received from the recording device which are compared against a database of key phrases related to a pre-operative assessment.

Summation

Accordingly, it has been shown that the present invention provides a number of advantages over the prior art. In particular, the system and method of the invention provides a failsafe method for ensuring strict compliance with the performance of a pre-operative assessment. By enforcing strict compliance with the pre-operative assessment, the possibility of by-passing the assessment or affirming that an assessment was performed at a later time is precluded. The method and system advantageously rely on a repeatable obligatory behavior that is easily implemented and can be added to existing physical infrastructure at a very low cost.

It is to be understood that this invention is not limited to the specific devices, methods, conditions, or parameters described and/or shown herein, and that the terminology used herein is for the purpose of describing particular embodiments by way of example only. Thus, the terminology is intended to be broadly construed and is not intended to be limiting of the claimed invention. For example, as used in the specification including the appended claims, the singular forms “a,” “an,” and “the” include the plural, the term “or” means “and/or,” and reference to a particular numerical value includes at least that particular value, unless the context clearly dictates otherwise. In addition, any methods described herein are not intended to be limited to the sequence of steps described but can be carried out in other sequences, unless expressly stated otherwise herein.

While the invention has been described with reference to an example embodiment, it will be understood by those skilled in the art that a variety of modifications, additions and deletions are within the scope of the invention, as defined by the following claims.

1-20. (canceled)

21. A method for ensuring compliance with pre-operative policies and procedures designed to prevent wrong site surgeries, the method comprising:
initializing one or more operating room components to a disabled state prior to a scheduled procedure;
receiving inputs related to a pre-operative assessment of a patient from a plurality of participants to the scheduled procedure;
receiving an indicia of personal identification from each of the plurality of participants as a form of attestation to their respective participation in the pre-operative assessment;
verifying the indicia of personal identification received from the plurality of participants;
enabling the one or more operating room components upon satisfying the verifying step; and
otherwise maintaining the operating room components in the disabled state when the verifying step is not satisfied.

22. The method of claim 21, wherein the one or more operating room components comprise any of one or more operating room lighting fixtures and one or more electrical outlets.

23. The method of claim 21, wherein the pre-operative assessment of the patient comprises any of a review of patient data, verification of patient identification, and verification of a surgery site on the patient.

24. The method of claim 21, wherein the verifying step is repeated as many times as any of the plurality of participants enter incorrect indicia of personal identification.

25. The method of claim 21, wherein the verifying step is repeated until a predetermined number of attempts for verifying the indicia of personal identification is reached, at which point the one or more operating room components are maintained in the disabled state and no further attempts for verifying the indicia of personal identification are provided.

26. The method of claim 21, wherein the indicia of personal identification comprises biometric information.

27. The method of claim 21, wherein prior to enabling the one or more operating room components, the method further comprises:
receiving an indicia of personal identification from the patient to attest to being informed of pre-operative information.

28. A method for controlling operation of one or more components of an operating room to ensure compliance with pre-operative policies and procedures designed to prevent wrong site surgeries, wherein the one or more components of the operating room are initialized to a disabled state prior to a scheduled procedure, the method comprising:
receiving an indicia of personal identification from each of a plurality of participants to the scheduled procedure;
receiving inputs verifying elements of a pre-operative assessment of a patient from the plurality of participants;
receiving an indicia of personal identification from the patient to attest to being informed of pre-operative related information;
verifying the indicia of personal identification received from the plurality of participants and the patient;
enabling the one or more operating room components when (1) the indicia of personal identification is verified for each of the plurality of participants and the patient and (2) the elements of the pre-operative assessment are verified by the plurality of participants; and
otherwise maintaining the operating room components in the disabled state when either (1) the indicia of personal identification is not verified for any of the plurality of participants and the patient or (2) any of the elements of the pre-operative assessment are not verified by the plurality of participants.

29. The method of claim 28, wherein the one or more operating room components comprise any of one or more operating room lighting fixtures and one or more electrical outlets.

30. The method of claim 28, wherein the pre-operative assessment of the patient comprises any of a review of patient data, verification of patient identification, and verification of a surgery site on the patient.

31. The method of claim 28, wherein the verifying step is repeated as many times as any of the plurality of participants enter incorrect indicia of personal identification.

32. The method of claim 28, wherein the verifying step is repeated until a predetermined number of attempts for verifying the indicia of personal identification is reached, at which point the one or more operating room components are maintained in the disabled state and no further attempts for verifying the indicia of personal identification are provided.

33. The method of claim 28, wherein the indicia of personal identification for any of the patient and the plurality of participants comprises biometric information.

34. The method of claim 28, wherein receiving inputs verifying elements of a pre-operative assessment of a patient from the plurality of participants comprises:
activating a recording device prior to the start of a pre-operative assessment;
recording the pre-operative assessment conducted by the plurality of participants while the recording device is activated; and
deactivating the recording device at the conclusion of the pre-operative assessment.

35. A system for controlling operation of one or more operating room components to ensure compliance with pre-operative policies and procedures designed to prevent wrong site surgeries, the system comprising:
a processing unit in communication with the one or more operating room components, wherein the processing unit initializes the one or more operating room components to a disabled state before a scheduled procedure; and
a device operable to receive indicia of personal identification from each of a patient and a plurality of participants to the scheduled procedure and to receive inputs verifying elements of a pre-operative assessment of the patient from the plurality of participants, wherein the processing unit is operable to verify the indicia of personal identification from the plurality of participants and the patient and to enable the one or more operating room components if (1) the indicia of personal identification is verified for each of the plurality of participants and the patient and (2) the elements of the pre-operative assessment are verified by the plurality of participants.

36. The method of claim 35, wherein the one or more operating room components comprise any of one or more operating room lighting fixtures and one or more electrical outlets.

37. The system of claim 35, wherein the device includes a display device for displaying pre-operative assessment information and patient information.

38. The system of claim 35, wherein the device comprises a biometric input device for receiving the indicia of personal identification from the patient and the plurality of participants.

39. The system of claim 35, and further comprising:
a data storage medium operable to store any of a personnel table of operating room personnel, a real-time status of the one or more operating room components pertaining to one or more scheduled procedures, and pre- and post-operative information regarding the one or more scheduled procedures.

40. The system of claim 39, wherein the pre- and post-operative information includes any of (1) date and time-stamp information pertaining to the date and time at which indicia of personal identification are verified by the system, and (2) a description of scheduled, on-going and completed surgical procedures.

41. A method for ensuring compliance with pre-operative policies and procedures designed to prevent wrong site surgeries, the method comprising:
disabling operating room functionality prior to a scheduled procedure;
receiving inputs related to a pre-operative assessment of a patient from a plurality of participants to the scheduled procedure;
receiving an indicia of personal identification from each of the plurality of participants as a form of attestation to their respective participation in the pre-operative assessment;
verifying the indicia of personal identification received from the plurality of participants;
enabling operating room functionality if (1) the indicia of personal identification is verified for each of the plurality of participants and (2) the elements of the pre-operative assessment are verified by the plurality of participants.

42. A device in a system for controlling operation of one or more operating room components to ensure compliance with pre-operative policies and procedures designed to prevent wrong site surgeries, wherein the system includes a processing unit that initializes the one or more operating room components to a disabled state before a scheduled procedure, the device comprising:
an identification input component operable to receive indicia of personal identification from each of a patient and a plurality of participants to the scheduled procedure; and
a user interface operable to receive inputs verifying elements of a pre-operative assessment of the patient from the plurality of participants, wherein the processing unit is operable to verify the indicia of personal identification from the plurality of participants and the patient and to enable the one or more operating room components if (1) the indicia of personal identification is verified for each of the plurality of participants and the patient and (2) the elements of the pre-operative assessment are verified by the plurality of participants.
